(19) United States
(12) Patent Application Publication
(10) Pub. No.: US 2023/0204869 A1
(43) Pub. Date: Jun. 29, 2023

(54) STRUCTURE FOR ATTACHING OBJECT TO BE ATTACHED AND METHOD FOR ATTACHING OBJECT TO BE ATTACHED

(71) Applicant: TOMOEGAWA CO., LTD., Tokyo (JP)

(72) Inventors: Makoto GOTO, Shizuoka-shi, Shizuoka (JP); Masayoshi SUZUKI, Shizuoka-shi, Shizuoka (JP)

(21) Appl. No.: 17/999,921

(22) PCT Filed: May 28, 2021
(86) PCT No.: PCT/JP2021/020551

§ 371 Date: Nov. 27, 2022

(30) Foreign Application Priority Data
Jun. 1, 2020 (JP) 2020-095732

(51) Int. Cl. G02B 6/38; B08B 7/00

(52) U.S. Cl. CPC G02B 6/3866; B08B 7/0028; B08B 2240/02

(57) ABSTRACT

Provided is a structure for attaching an object to be attached capable of maintaining an appropriate attachment state of an object to be attached by attaching the object to be attached to an attachment portion with distortion being less likely to be accumulated. The structure for attaching an object to be attached, includes an object to be attached including a first surface having an adhesive layer and a second surface which is a surface on a side opposite to the first surface and has no adhesive layer, and an attachment portion to which the object to be attached is attached to face the second surface of the object to be attached, and at least a part of the object to be attached is deformable in a state where the object to be attached is attached.

### TECHNICAL FIELD

The present invention relates to a structure for attaching an object to be attached for attaching an object to be attached to an attachment portion, and a method for attaching an object to be attached for attaching the object to be attached to the attachment portion.

### BACKGROUND ART

There is an optical connector cleaning tool for cleaning an optical connector as a tool including a reel or a bobbin around which a flexible medium such as an elongated tape is wound. The optical connector cleaning tool has a configuration in which a tape-shaped nonwoven fabric is wound around a reel in advance, is brought into contact with an end surface of a ferrule of an optical connector to clean the nonwoven fabric, and is then wound (See, for example, Patent Literatures 1 and 2.).

### CITATION LIST

### Patent Literature

Patent Literature 1: JP 2014-35489 A

Patent Literature 2: Japanese Patent No. 5955453

### SUMMARY OF INVENTION

### Technical Problem

As described above, in an instrument or a device using a flexible medium having an elongated shape, it is necessary to wind the medium around a reel, a bobbin, or the like in advance. Specifically, it is necessary to perform a process of connecting the medium to a shaft core of the reel or the bobbin, rotating the reel or the bobbin, and winding the medium around the shaft core. Since the medium has flexibility, stress is applied to the medium by the rotation of the reel or the bobbin, and distortion occurs. For example, shear strain or the like is generated in the medium by stress. In the process of winding the medium, the medium may be wound before the distortion is sufficiently released, and the medium may be superimposed one after another with distortion. For this reason, distortion is accumulated on the medium overlapping each other everywhere.

Even when the medium seems to be appropriately wound at the time when the winding process is completed, since distortion is accumulated in the wound medium, the distortion is then released over time. With the release of the distortion, a phenomenon occurs in which lateral displacement (displacement in the width direction of the medium) occurs in the medium and the entire shape of the wound medium is displaced in a spiral shape. In other words, the entire shape of the wound medium is deformed into a so-called bamboo shoot shape with time. For example, when a wound medium is stored in a high temperature environment, the medium tends to be displaced in a spiral shape.

Therefore, when the entire shape of the wound medium is displaced in a spiral shape after the wound medium is stored in an instrument or a device, it may be difficult to pull out the medium from the instrument or the device, or the medium may be damaged.

It is understood that the formation of the spiral shape (bamboo shoot shape) is caused by winding tightening. The winding tightening refers to a phenomenon in which the medium is wound with a partially loosely wound portion. When the accumulated distortion is released, lateral displacement occurs at the loosely wound portion, and a spiral shape (bamboo shoot shape) is easily formed.

The present invention has been made in view of the above points, and an object of the present invention is to provide a structure for attaching an object to be attached and a method for attaching an object to be attached capable of attaching an object to be attached such as a medium with distortion being less likely to be accumulated and maintaining an appropriate attachment state of the object to be attached.

### Solution to Problem

According to an aspect of the present invention, there is provided a structure for attaching an object to be attached, including:

an object to be attached including a first surface having an adhesive layer and a second surface which is a surface on a side opposite to the first surface and has no adhesive layer; and

an attachment portion to which the object to be attached is attached to face the second surface of the object to be attached, at least a part of the object to be attached being deformable in a state where the object to be attached is attached.

According to another aspect of the present invention, there is provided a method for attaching an object to be attached including:

attaching an object to be attached to an attachment portion so that the attachment portion faces a second surface of the object to be attached including a first surface having an adhesive layer and the second surface which is a surface on a side opposite to the first surface and has no adhesive layer face each other, in which at least a part of the object to be attached is deformable in a state where the object to be attached is attached.

### Advantageous Effects of Invention

It is possible to attach an object to be attached to an attachment portion with distortion being less likely to be accumulated and maintain an appropriate attachment state of the object to be attached.

### BRIEF DESCRIPTION OF DRAWINGS

FIG. 1 is a perspective view illustrating an outline of an entire cleaning tool 10 and an optical connector OC according to the present embodiment.

FIG. 2 is a perspective view illustrating a state in which a left housing 110L of the cleaning tool 10 according to the present embodiment is removed.

FIG. 3 is a perspective view illustrating a state in which a winding reel 300 of the cleaning tool 10 according to the present embodiment is removed.

FIG. 4 is a perspective view illustrating a path of a cleaning body CT in a head portion 400 of the cleaning tool 10 according to the present embodiment.

FIG. 5 is a perspective view illustrating a structure of the winding reel 300.

FIG. 6 is a front view illustrating the structure of the winding reel 300.

FIGS. 7A to 7F are schematic views illustrating a process of attaching the cleaning body CT to the winding reel 300.

FIG. 8 is a front view illustrating a state in which the cleaning body CT is attached to the winding reel 300.

FIGS. 9A to 9E are schematic views illustrating the process of attaching the cleaning body CT to the winding reel 300.

FIG. 10 is a front view illustrating the state in which the cleaning body CT is attached to the winding reel 300.

FIG. 11 is a front view illustrating the state in which the cleaning body CT is attached to the winding reel 300.

### DESCRIPTION OF EMBODIMENTS

### Outline of Present Embodiment

### First Aspect

According to a first aspect,

there is provided a structure for attaching an object to be attached, including:

an object to be attached (for example, a cleaning body CT or the like) including a first surface (for example, a first surface RS to be described later and the like) having an adhesive layer and a second surface (for example, a second surface NS to be described later or the like) which is a surface on a side opposite to the first surface and has no adhesive layer; and

an attachment portion (for example, an attachment portion 224 of a supply reel 200 to be described later and the like) to which the object to be attached is attached to face the second surface of the object to be attached, at least a part (for example, an annular portion LP to be described later and the like) of the object to be attached being deformable in a state where the object to be attached is attached.

The structure for attaching an object to be attached includes the object to be attached and the attachment portion.

The object to be attached has the first surface and the second surface. The first surface has the adhesive layer. The second surface is a surface on the side opposite to the first surface. The second surface has no adhesive layer.

First, the object to be attached is attached to the attachment portion to face the second surface of the object to be attached. That is, the second surface of the object to be attached is in direct contact with the attachment portion, and not the first surface of the object to be attached. Since the second surface does not have the adhesive layer, the object to be attached does not stick or adhere to the attachment portion. Since at least a part of the object to be attached does not stick or adhere to the attachment portion, the object to be attached can be deformed in a state of being attached to an attachment portion.

Since at least a part of the object to be attached can be deformed in a state of being attached to the attachment portion, stress applied to the object to be attached can be dispersed when the object to be attached is attached to the attachment portion. That is, even when stress is intensively applied to a specific position of the object to be attached in the attachment process, the posture and position of at least a part of the object to be attached can be finely adjusted by deformation of at least a part of the object to be attached. It is possible to disperse the stress applied to the object to be attached by fine adjustment of the posture and the position, release the distortion generated by the stress, and then attach the object to be attached to the attachment portion. By attaching the object to be attached so as not to accumulate distortion, it is possible to prevent displacement of the medium over time after the attachment and maintain a state in which the object to be attached is attached to the attachment portion.

At least a part of the object to be attached can be deformed, and can slide, move, and be displaced with respect to the attachment portion.

### Second Aspect

According to a second aspect, in the first aspect,

at least a part of the object to be attached is deformable in a direction (for example, a radial direction, a circumferential direction, or the like of an attachment portion 224 to be described later) away from or approaching the attachment portion.

Since at least a part of the object to be attached can be deformed in the direction away from or approaching the attachment portion, at least a part of the object to be attached can slide, move, and be displaced with respect to the attachment portion. In this way, it is possible to disperse the stress applied to the object to be attached, attach the object to be attached so as not to accumulate distortion, and maintain the state in which the object to be attached is attached.

### Third Aspect

According to a third aspect, in the second aspect,

after the object to be attached is attached to face the second surface of the object to be attached, the object to be attached is attached so that the first surface of the object to be attached faces the attachment portion.

More specifically, in the third aspect,

after the object to be attached is attached to face the second surface of the object to be attached, the first surface of the object to be attached is attached to an object to be attached already attached to the attachment portion.

Still more specifically, in the third aspect,

after the object to be attached is attached to face the second surface of the object to be attached, the first surface of the object to be attached is attached to face the first surface of the object to be attached already attached to the attachment portion.

At least a part of the object to be attached is attached to the attachment portion without sticking or adhering to the attachment portion. At least a part of the object to be attached is attached to the attachment portion with a clearance in the attachment portion, and can slide, move, and be displaced with respect to the attachment portion. Further, the first surface of the object to be attached is newly attached to the first surface of the object to be attached already attached to the attachment portion. Therefore, by facing the already attached first surface and the newly attached first surface, the adhesive layer can be laminated and the adhesive layer can be made substantially thick. By thickening the adhesive layer, a restoring force (biasing force) is increased, the stress applied to the object to be attached is quickly alleviated, and the object to be attached can be attached after the distortion is sufficiently eliminated. As described above, sliding, movement, and displacement of at least a part of the object to be attached with respect to the attachment portion, and rapid relaxation of stress allow the object to be attached to be attached so that distortion is not accumulated, and a state in which the object to be attached is to the attachment portion can be maintained.

### Fourth Aspect

According to a fourth aspect, in the third aspect,

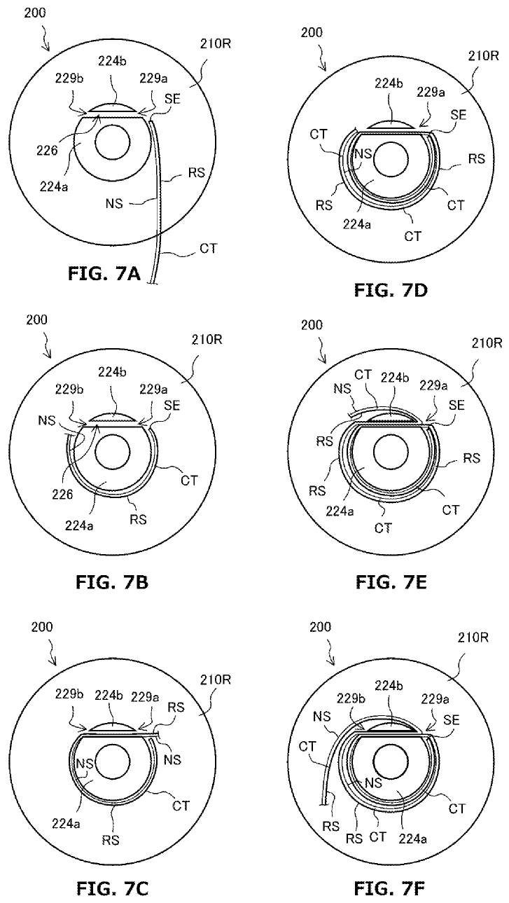

after the object to be attached is wound in a first winding direction (for example, clockwise in FIGS. 7A to 11 described later, and the like) to face the second surface of the object to be attached, the object to be attached is wound in a second winding direction (for example, counterclockwise in FIGS. 7A to 11 described later, and the like) different from the first winding direction so that the first surface of the object to be attached faces the attachment portion.

More specifically, in the fourth aspect,

after the object to be attached is wound in the first winding direction (for example, clockwise in FIGS. 7A to 11 described later, and the like) to face the second surface of the object to be attached, the first surface of the object to be attached is wound around the object to be attached already wound around the attachment portion in a second winding direction (for example, counterclockwise in FIGS. 7A to 11 described later, and the like) different from the first winding direction.

It is possible to slide, move, and displace with respect to the attachment portion by securing a clearance of a portion directly in contact with the attachment portion. Further, the adhesive layer is laminated by the already attached first surface and the newly attached first surface to substantially thicken the adhesive layer. By thickening the adhesive layer, the stress applied to the object to be attached can be quickly alleviated, and the object to be attached can be attached after the distortion is reliably eliminated. Due to sliding, movement, and displacement of at least a part of the object to be attached with respect to the attachment portion, and rapid relaxation of stress, the object to be attached can be attached such that distortion is not accumulated, and a state in which the object to be attached is attached can be maintained.

### Fifth Aspect

According to a fifth aspect, in the fourth aspect,

the attachment portion includes an engagement portion (for example, a second attachment portion 224b to be described later and the like) engageable with the object to be attached and configured to change a winding direction of the object to be attached from the first winding direction to the second winding direction by engagement.

The attachment portion has the engagement portion. The attachment portion can be engaged with the object to be attached. The attachment portion engages with the object to be attached to change the winding direction of the object to be attached from the first winding direction to the second winding direction.

The winding direction of the object to be attached can be appropriately changed, and the object to be attached can be slid, moved, and displaced with respect to the attachment portion by securing a clearance of a portion directly in contact with the attachment portion. By facing the already attached first surface and the newly attached first surface, the adhesive layer is laminated to thicken the adhesive layer. By thickening the adhesive layer, stress applied to the object to be attached can be quickly alleviated, and the object to be attached can be attached after distortion is reliably eliminated. Due to sliding, movement, and displacement of at least a part of the object to be attached with respect to the attachment portion, and rapid relaxation of stress, the object to be attached can be attached so that distortion is not accumulated, and a state in which the object to be attached is attached can be maintained.

### Sixth Aspect

According to a sixth aspect,

there is provided a method for attaching an object to be attached including: attaching an object to be attached to an attachment portion (for example, an attachment portion 224 of a supply reel 200 to be described later and the like) so that the attachment portion faces a second surface of the object to be attached (for example, a cleaning body CT to be described later and the like) including a first surface (for example, a first surface RS to be described later and the like) having an adhesive layer and the second surface (for example, a second surface NS to be described later and the like) which is a surface on a side opposite to the first surface and has no adhesive layer,

in which at least a part (for example, an annular portion LP to be described later and the like) of the object to be attached is deformable in a state where the object to be attached is attached.

The object to be attached has the first surface and the second surface. The first surface has the adhesive layer. The second surface is the surface on the side opposite to the first surface. The second surface has no adhesive layer.

First, the object to be attached is attached to the attachment portion to face the second surface of the object to be attached. That is, the second surface of the object to be attached is in direct contact with the attachment portion, and not the first surface of the object to be attached. Since the second surface does not have the adhesive layer, the object to be attached does not stick or adhere to the attachment portion. Since at least a part of the object to be attached does not stick or adhere to the attachment portion, the object to be attached can be deformed in a state of being attached to the attachment portion.

Since at least a part of the object to be attached can be deformed in a state of being attached to the attachment portion, stress applied to the object to be attached can be dispersed when the object to be attached is attached to the attachment portion. That is, even when stress is intensively applied to a specific position of the object to be attached in the attachment process, the posture and position of at least a part of the object to be attached can be finely adjusted by deformation of at least a part of the object to be attached. It is possible to disperse the stress applied to the object to be attached by fine adjustment of the posture and the position, release the distortion generated by the stress, and then attach the object to be attached to the attachment portion. By attaching the object to be attached so as not to accumulate distortion, it is possible to prevent displacement of the medium over time after the attachment and maintain a state in which the object to be attached is attached to the attachment portion.

At least a part of the object to be attached can be deformed, and can slide, move, and be displaced with respect to the attachment portion.

### Seventh Aspect

According to a seventh aspect, in the sixth aspect,

after the object to be attached is attached to the attachment portion to face the second surface of the object to be attached, the object to be attached is attached to the attachment portion to face the first surface of the object to be attached.

More specifically, in the seventh aspect,

after the object to be attached is attached to face the second surface of the object to be attached, the first surface of the object to be attached is attached to an object to be attached already attached to the attachment portion.

Still more specifically, in the seventh aspect,

after the object to be attached is attached to face the second surface of the object to be attached, the first surface of the object to be attached is attached to face the first surface of the object to be attached already attached to the attachment portion.

At least a part of the object to be attached is attached to the attachment portion without sticking or adhering to the attachment portion. At least a part of the object to be attached is attached to the attachment portion with a clearance in the attachment portion, and can slide, move, and be displaced with respect to the attachment portion. Further, the first surface of the object to be attached is newly attached to the first surface of the object to be attached already attached to the attachment portion. Therefore, by facing the already attached first surface and the newly attached first surface, the adhesive layer can be laminated and the adhesive layer can be made substantially thick. By thickening the adhesive layer, the restoring force (biasing force) is increased, the stress applied to the object to be attached is quickly alleviated, and the object to be attached can be attached after the distortion is reliably eliminated. As described above, sliding, movement, and displacement of at least a part of the object to be attached with respect to the attachment portion, and rapid relaxation of stress allow the object to be attached to be attached so that distortion is not accumulated, and a state in which the object to be attached is attached can be maintained.

### Eighth Aspect

According to an eighth aspect, in the seventh aspect,

after the object to be attached is wound in a first winding direction to face the second surface of the object to be attached, the object to be attached is guided in a second winding direction different from the first winding direction and the first surface of the object to be attached is wound to face the attachment portion.

More specifically, the eighth aspect,

after the object to be attached is wound in the first winding direction (for example, clockwise in FIGS. 7A to 11 described later, and the like) to face the second surface of the object to be attached, the first surface of the object to be attached is wound around an object to be attached already wound around the attachment portion in the second winding direction (for example, counterclockwise in FIGS. 7A to 11 described later, and the like) different from the first winding direction.

It is possible to slide, move, and displace with respect to the attachment portion by securing a clearance of a portion directly in contact with the attachment portion. Further, the adhesive layer is laminated by the already attached first surface and the newly attached first surface to substantially thicken the adhesive layer. By thickening the adhesive layer, the stress applied to the object to be attached can be quickly alleviated, and the object to be attached can be attached after the distortion is sufficiently eliminated. Due to sliding, movement, and displacement of at least a part of the object to be attached with respect to the attachment portion, and rapid relaxation of stress, the object to be attached can be attached such that distortion is not accumulated, and a state in which the object to be attached is attached can be maintained.

### Ninth Aspect

Preferably, the object to be attached has an elongated shape.

### Tenth Aspect

Preferably, the object to be attached has flexibility.

### Eleventh Aspect

Preferably, the object to be attached is wound in the first winding direction and then reversed and wound in the second winding direction.

### Twelfth Aspect

Preferably, the attachment portion includes a first attachment portion and a second attachment portion spaced apart from the first attachment portion with a gap,

the object to be attached is wound around the first attachment portion so as to face the second surface of the object to be attached to the first attachment portion,

the object to be attached is guided to the gap,

the object to be attached is wound around the second attachment portion so as to face the first surface of the object to be attached to the second attachment portion, and

the object to be attached is wound around the first attachment portion and the second attachment portion.

### Thirteenth Aspect

Preferably, the first attachment portion is larger than the second attachment portion.

### Fourteenth Aspect

Preferably, the attachment portion having the first attachment portion and the second attachment portion has a cylindrical shape or a columnar shape.

### Details of Present Embodiment

Hereinafter, the present embodiment will be described with reference to the drawings. In the present embodiment, a cleaning body CT for cleaning a ferrule end surface OE of an optical connector OC will be described as an example of the object to be attached of a structure for attaching an object to be attached or a method for attaching an object to be attached. It should be noted that the present invention is not limited to the cleaning body CT, and any cleaning body may be used as long as the cleaning body CT can be used for a structure for attaching an object to be attached and a method for attaching an object to be attached for attaching an object to be attached having an adhesive layer, such as an IC tag label or a circuit connection tape.

### Cleaning Tool 10

A cleaning tool 10 is a cleaning tool for an optical connector for cleaning the ferrule end surface OE of the optical connector OC using the cleaning body CT.

### Direction

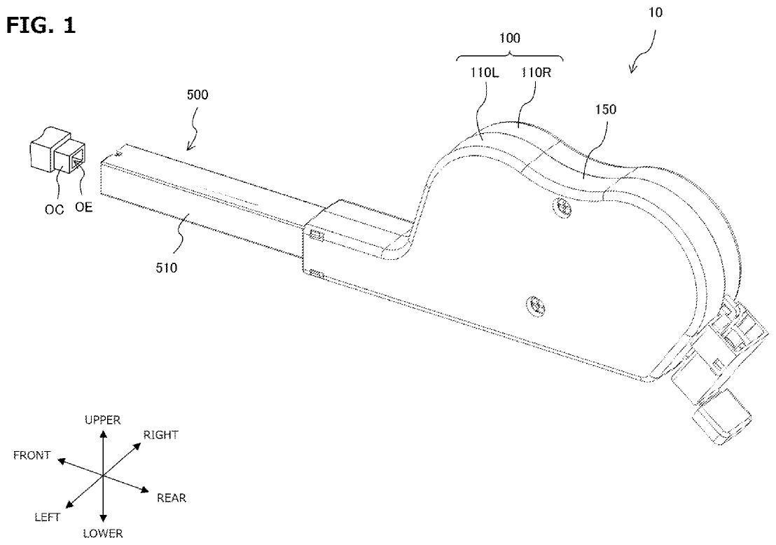

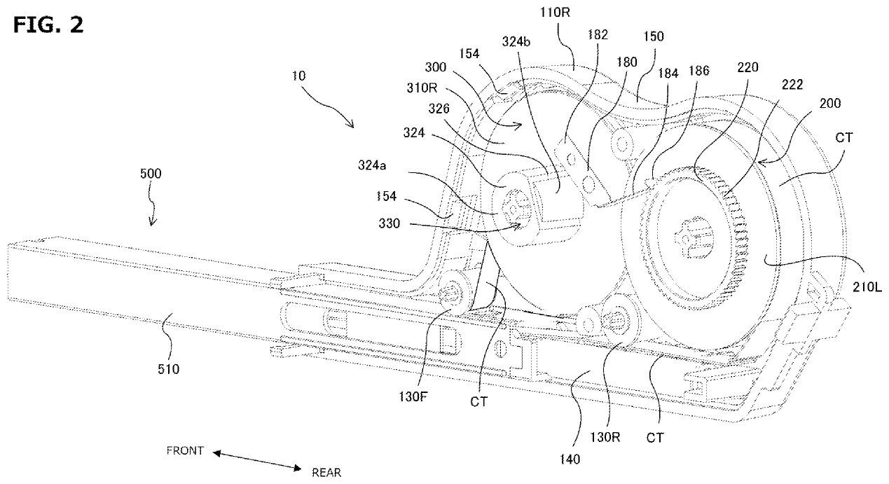

Directions used in the present specification will be described (see FIGS. 1 and 2).

### Front, Rear, Longitudinal

A side or a direction on which a cleaning head 410 of the cleaning tool 10 is located is defined as a front side or a front direction, and a side or a direction on which a housing 100 is located is defined as a rear side or a rear direction. A front-rear direction may be referred to as a longitudinal direction of the head portion 400.

### Right and Left

A right side or a direction from the rear side to the front side is referred to as a right side or a right direction, and a left side or a direction from the rear side to the front side is referred to as a left side.

### Lower and Upper

A side or a direction on which a coil spring 140 is located is referred to as a lower side, a downward direction, or a lower portion, and a side or a direction on which a supply reel 200 or a winding reel 300 is located is referred to as an upper side, an upward direction, or an upper portion.

### Upstream and Downstream

A side on which the cleaning body CT is delivered and supplied is referred to as upstream, and the side on which the cleaning body CT is wound is referred to as downstream. The supply reel 200 to be described later is located upstream, and the winding reel 300 is located downstream.

### Width Direction

A direction along a width of the cleaning body CT is referred to as a width direction. As described later, the cleaning body CT has an elongated shape, and the cleaning body CT has a longitudinal direction and a lateral direction. The longitudinal direction of the cleaning body CT is a direction on a long side of the cleaning body CT. The lateral direction of the cleaning body CT is the same as the width direction of the cleaning body CT.

The width direction of the supply reel 200 and the width direction of the winding reel 300, which will be described later, are the same as the width direction of the cleaning body CT in a state where the cleaning body CT is wound.

### Cleaning Body CT

The cleaning body CT is long and flexible, and has an adhesive layer (resin layer) on at least a part thereof. The adhesive layer comes into contact with the ferrule end surface OE of the optical connector OC and a guide pin GP (not illustrated), so that dirt such as dust can be removed. The cleaning body CT has, for example, an integral and continuous shape such as a tape-like shape or a thread shape.

The width of the cleaning body CT is not particularly limited. The width of the cleaning body CT can be equal to or larger than the width of the ferrule end surface OE of the optical connector OC. Furthermore, the width of the cleaning body CT may be equal to or larger than the width including the guide pin GP (not illustrated).

The thickness of the cleaning body CT is not particularly limited, but can be, for example, 0.05 mm to 2 mm.

The cleaning body CT may be an adhesive layer alone or may be laminated on the base material. Further, a release film may be laminated. The base material can be used as a support material when the base material cannot be supported as the cleaning body CT only with the adhesive layer. The release film can be used to protect a cleaning surface of the cleaning body CT from dirt and damage while the cleaning tool 10 of the present invention is not used.

The cleaning body CT is sent to a cleaning body head, and is brought into contact with the ferrule end surface OE and the guide pin GP (not illustrated) of the optical connector OC on the cleaning body head. The base material is laminated on the surface of the adhesive layer in contact with the cleaning body head. The release film is laminated on the surface of the adhesive layer on the side opposite to the base material. The release film is released before the cleaning body CT reaches the cleaning body head, and is excluded from the cleaning body CT.

The adhesive layer is not particularly limited as long as dirt can be removed by contact with the ferrule end surface OE of the optical connector OC and the guide pin GP (not illustrated), and examples thereof include a resin, a nonwoven fabric, a woven fabric, and the like having flexibility that allows an adhesive, a resin foam (foam), and the guide pin GP (not illustrated) to be embedded, pierced, or penetrated.

As the material of the adhesive, a known material can be used, and examples thereof include rubber-based adhesives, acryl-based adhesives, silicone-based adhesives, and urethane-based adhesives. Additives such as a tackifier and a filler may be blended in these adhesives. The known adhesive is easily available, and has an advantage that an adhesive strength and an adhesive residue preventing effect can be easily modified.

The adhesive may be an adhesive agent as long as it has a function of attaching dirt to the cleaning body CT by contact, and for example, an olefin-based adhesive having weak adhesiveness can be used. The adhesive agent is preferably subjected to a measure of suppressing or preventing contamination of the ferrule end surface OE of the optical connector OC such as adhesive residue on the ferrule end surface OE when the adhesive is brought into contact with the ferrule end surface OE of the optical connector OC and the guide pin GP (not illustrated).

As the resin foam (foam), a known resin foam can be used. Although it is necessary to verify the mechanism by which dirt can be captured on the cleaning surface formed by the resin foam (foam) for clarification, for example, it is conceivable as an example that dirt pressed against the flexible cleaning surface is buried (or semi-buried) in the resin foam (foam), is hardly detached from the cleaning surface, and is captured by the resin foam (foam).

As another consideration example, when the ferrule end surface OE and the guide pin GP of the optical connector OC are pressed against the resin foam (foam), cells in the resin foam (foam) are crushed, and the air inside is pushed out. Further, a part of open cells is crushed and blocked. At this time, the surface of the resin foam (foam), the ferrule end surface OE of the optical connector OC, and the surface of the guide pin GP are sucked under reduced pressure. Furthermore, it is also conceivable as an example that small dust is sucked into cells, and dust larger than the cells is adsorbed by depressurization in the cells.

As a result of various tests, it has been found that no foreign matter adheres to the guide pin GP even when the resin foam (foam) penetrates the guide pin GP. Since the resin foam (foam) has cells, the resin foam is made of a very flexible material, and the guide pin GP easily pierces and penetrates. Therefore, when the guide pin GP pierces and penetrates the resin foam (foam), the resin foam (foam) is entangled with the side surface portion of the guide pin GP, and dust on the side surface portion of the guide pin GP can be efficiently removed. Any material other than the resin foam can be suitably used as long as foreign matter does not adhere to the guide pin GP due to penetration.

The material of the resin foam (foam) is not particularly limited, and a known material can be used. Examples thereof include a resin foam (foam) containing a urethane resin, a (meth) acrylic resin, a saturated polyester resin, a vinyl acetate-based resin, a vinyl chloride-based resin, an epoxy-based resin, an olefin resin, a styrene resin, a melamine resin, a urea resin phenol resin, a silicone resin, and the like. These materials can be used at least one or in combination of two or more thereof. Among them, urethane foams are suitable because they have excellent flexibility and low compressive residual distortion. In addition, it is also preferable to use a (meth) acrylic foam because it is excellent in strength, lightweight, and heat insulating properties. When a urethane foam and a (meth) acrylic foam are mixed and used, the resin foam (foam) is suitable because the properties of the urethane foam and the properties of the acrylic foam can be adjusted depending on a mixing ratio of the urethane foam and the (meth) acrylic foam.

The structure of the cells contained in the resin foam (foam) is not particularly limited, and a known structure can be used. The structure of the cells may have a closed cell structure in which each cell is independently present in the resin foam (foam), or an open cell structure in which each cell is continuously connected in the resin foam (foam). The open cell structure includes a case where each cell is connected by a communication through hole and a case where a wall portion of a closed cell is broken and connected. As described above, since the guide pin GP easily pierces or penetrates the resin foam (foam) and dust can be efficiently removed, the resin foam (foam) having the open cell structure is preferable.

The method for producing the resin foam (foam) is not particularly limited, and a foam can be produced by a known method. For example, the resin foam (foam) may be produced by either a chemical foaming method or a physical foaming method, or may be an open cell foam in which closed cells are formed, and then the closed cells are physically pulverized and communicated. For example, a method for producing a foam disclosed in JP 2012-56985 A is suitable.

As the resin having flexibility, a known resin can be used, and examples thereof include a polyurethane resin and a polyacrylic resin. In addition, a gel material obtained by gelling them can be included. As the gel material, a soft polyurethane resin generally called a polyurethane gel can be used. The gel material is easily deformed, and at the same time, the guide pin GP can be easily embedded, pierced, or penetrated. In this case, even when the adhesive strength of the gel material is weak, dirt can be removed from the ferrule end surface OE and the guide pin GP of the optical connector OC by the burying effect due to the softness of the soft polyurethane and piercing or penetrating.

In addition, since the gel material is slightly adhesive, the optical connector OC is easily detached, adhesive residue or the like does not occur, and the soft polyurethane to which dirt adheres can be reused by cleaning the surface with a dust-free cloth wetted with water. As the soft polyurethane, for example, a soft composition disclosed in JP 2001-316448 A and the like can be suitably used.

### Contaminant Collector (Hereinafter, also Referred to as Adhesive Layer)

The composition of the adhesive layer is not limited, but the adhesive layer contains a polyurethane resin, has an Asker C hardness of 45 to 90, and has a tensile strength of 2.0 MPa or more and 30 MPa or less.

When the adhesive layer has the above characteristics, the adhesive layer can follow the shape of the surface to be cleaned. In particular, when the adhesive layer is used for a connection end surface of an optical connector for an optical fiber in which a guide pin protrudes, the adhesive layer can follow the shape of the guide pin, and the cleaning effect on the guide pin and the optical connector connection end surface is remarkably high. Further, since contaminants once collected on the adhesive layer do not adhere again to the surface to be cleaned, the cleaner can be used as a cleaner having an extremely high cleaning effect.

The shape of the adhesive layer is not particularly limited, and may be, for example, a band-like or sheet-like film, a rod-like, columnar, weight, frustum, or block-like polygonal body or circular body, an elliptical body, a spherical shape, or an elliptical spherical shape.

The adhesive layer may be laminated on the base material, the support, or the adhesive layer holder directly or via another layer, or may be accommodated in an accommodating body or the like in a state where a part thereof is exposed.

The base material may include a release layer on a surface of the base material facing a surface on which the collector is laminated.

The adhesive layer may be wound in a spiral shape.

### Polyurethane Resin

The adhesive layer contains a polyurethane resin. The composition of the polyurethane resin is not limited as long as the polyurethane resin has the mechanical characteristics of the adhesive layer.

The polyurethane resin has a polyol component and a polyisocyanate component, and may contain other components in its composition.

### Polyol Component

The polyurethane resin contains a polyol component. The polyol component can contain a plurality of types of polyols.

The number of hydroxyl groups (hereinafter, may be referred to as the number of functional groups) contained in the structure of one molecule of the polyol component is 2 to 5, preferably 2 to 3. When the number of hydroxyl groups of the polyol is in such a range, it is possible to obtain a polyurethane resin product which has good elongation, is hardly broken, and has high shape followability. When a plurality of kinds of polyols are contained as the polyol component, the number of hydroxyl groups of the polyol component can be obtained by adding a value obtained by multiplying a ratio of a blending amount of each polyol and the number of hydroxyl groups of each polyol.

A number average molecular weight of the polyol component can be 100 to 6000. When the number average molecular weight of the polyol component is within such a range, it is possible to obtain a polyurethane resin product which has good elongation, is hardly broken, and has high shape followability.

The polyol is not particularly limited as long as the above-mentioned characteristics are satisfied. Examples of the polyol include polyester polyols, polycarbonate polyols, polyether polyols, polyester ether polyols, polydiene-based polyols, hydrogenated polydiene polyols, and polymer polyols thereof. The polyols may be used singly or in combination of two or more kinds thereof.

Examples of the polyester polyol include polyester polyols obtained by dehydration condensation reaction of a polyol and a polycarboxylic acid, and polyester polyols obtained by ring-opening polymerization of lactone monomers such as ε-caprolactone and methylvalerolactone.

The polyol forming the polyester polyol is not particularly limited as long as the effect is not impaired. Examples of the polyol can include aliphatic polyols such as ethylene glycol, 1,3-propylene glycol, 1,2-propylene glycol, 1,3-butanediol, 1,4-butanediol, 1,5-pentanediol, 1,6-hexanediol, 3-methyl-1, 5-pentanediol, neopentyl glycol, 1,8-octanediol, 1,9-nonanediol, 1,4-tetracosanediol, 1,6-tetracosanediol, 1,4-hexacosanediol, 1,6-octacosanediol glycerin, trimethylolpropane, trimethylolethane, hexanetriol, pentaerythritol, sorbitol, mannitol, sorbitan, diglycerin, and dipentaerythritol; alicyclic polyols such as 1,2-cyclohexanediol, 1,4-cyclohexanediol, cyclohexanedimethanol, tricyclodecanedimethanol, cyclopentadienedimethanol, 2,5-norbornanediol, 1,3-adamantanediol and dimer diol; and aromatic polyols such as bisphenol A, bisphenol F, phenol novolac, and cresol novolac. These can be used singly or in combination of two or more thereof.

The polycarboxylic acid is not particularly limited as long as it has a plurality of carboxyl groups in its molecular structure and does not inhibit the effect. Examples of the polycarboxylic acid can include aliphatic polycarboxylic acids such as succinic acid, adipic acid, sebacic acid, and azelaic acid; aromatic polycarboxylic acids such as phthalic acid, terephthalic acid, isophthalic acid, and naphthalenedicarboxylic acid; alicyclic polycarboxylic acids such as hexahydrophthalic acid, hexahydroterephthalic acid, and hexahydroisophthalic acid; or an acid ester thereof. These can be used singly or in combination of two or more thereof.

Examples of the polycarbonate polyol can include those obtained by reacting at least one of polyhydric alcohols such as ethylene glycol, 1,2-propylene glycol, 1,3-propylene glycol, 1,3-butanediol, 1,4-butanediol, 1,5-pentanediol, 1,6-hexanediol, 3-methyl-1, 5-pentanediol, neopentyl glycol, 1,8-octanediol, 1,9-nonanediol, and diethylene glycol with diethylene carbonate, dimethyl carbonate, diethyl carbonate, and the like.

Examples of the polyether polyol include polyethylene glycol obtained by polymerizing cyclic ethers such as ethylene oxide, propylene oxide, and tetrahydrofuran, polypropylene glycol, polytetramethylene ether glycol, and the like, and copolyethers thereof. In addition, it can also be obtained by polymerizing the cyclic ether using a polyhydric alcohol such as glycerin or trimethylolethane.

Examples of the polyester ether polyol include those obtained by a dehydration condensation reaction of a polycarboxylic acid and a glycol such as diethylene glycol or a propylene oxide adduct.

Examples of the polycarboxylic acid can include aliphatic polycarboxylic acids such as succinic acid, adipic acid, sebacic acid, and azelaic acid; aromatic polycarboxylic acids such as phthalic acid, terephthalic acid, isophthalic acid, and naphthalenedicarboxylic acid; alicyclic polycarboxylic acids such as hexahydrophthalic acid, hexahydroterephthalic acid, and hexahydroisophthalic acid; or an acid ester thereof. These can be used singly or in combination of two or more thereof.

Polymeric polyols are obtained by in-situ polymerization of ethylenically unsaturated monomers in polyols. Examples of the ethylenically unsaturated monomer include acrylic-based monomers such as (meth) acrylonitrile, alkyl (C1 to 20 or more) (meth) acrylate (methyl methacrylate, or the like); hydrocarbon-based monomers, for example, aromatic unsaturated hydrocarbons (such as styrene), aliphatic unsaturated hydrocarbons (C2 to 20 or more alkenes, alkadienes, and the like, for example, α-olefin, butadiene, and the like); and a combination of two or more thereof [for example, a combination of acrylonitrile/styrene (weight ratio: 100/0 to 80/20)].

Among these polyols, it is preferable to contain a polyether polyol, a polyester polyol, and a polymer polyol, and it is more preferable to use a mixture of at least two of these polyols. When these polyols are used, it is possible to obtain a polyurethane resin product which has good elongation, is hardly broken, and has high shape followability.

### Polyisocyanate Component

The polyisocyanate is not particularly limited as long as the effect is not inhibited. Examples of the bifunctional polyisocyanate include aromatic polyisocyanate such as 2,4-toluene diisocyanate (2,4-TDI), 2,6-toluene diisocyanate (2,6-TDI), m-phenylene diisocyanate, p-phenylene diisocyanate, 4,4′-diphenylmethane diisocyanate (4,4′-MDI), 2,4′-diphenylmethane diisocyanate (2,4′-MDI), 2,2′-diphenylmethane diisocyanate (2,2′-MDI), hydrogenated MDI, monomeric diphenylmethane diisocyanate (monomeric MDI), xylylene diisocyanate, 3,3′-dimethyl-4, 4′-biphenylene diisocyanate, 3,3′-dimethoxy-4, 4′-biphenylene diisocyanate, polymethylene polyphenyl polyisocyanate, 1,5-naphthalene diisocyanate, xylylene diisocyanate (XDI), and hydrogenated XDI, and tetramethylxylene diisocyanate (TMXDI); cycloaliphatic polyisocyanate such as cyclohexane-1,4-diisocyanate, isophorone diisocyanate, dicyclohexylmethane-4,4′-diisocyanate, and methylcyclohexane diisocyanate; and alkylene polyisocyanate such as butane-1, 4-diisocyanate, hexamethylene diisocyanate, isopropylene diisocyanate, methylene diisocyanate, and lysine diisocyanate, and examples of the tri-or more functional polyisocyanate include 1-methylbenzol-2,4,6-triisocyanate, 1,3,5-trimethylbenzol-2,4,6-triisocyanate, biphenyl-2,4,4′-triisocyanate, diphenylmethane-2,4,4′-triisocyanate, methyldiphenylmethane-4,6,4′-triisocyanate, 4,4′-dimethyldiphenylmethane-2,2′,5,5′ tetraisocyanate, triphenylmethane-4,4′, 4′-triisocyanate, polymeric MDI, lysine ester triisocyanate, 1,3,6-hexamethylene triisocyanate, 1,6,11-undecane triisocyanate, bicycloheptane triisocyanate, 1,8-diisocyanatomethyloctane, and the like; and modified products thereof; derivatives and the like. One or more of these isocyanates can be used in combination.

Among these isocyanates, aromatic and aliphatic isocyanates are preferably contained, aromatic isocyanates are more preferably contained, and 4,4′-diphenylmethane diisocyanate (4,4′-MDI), 2,4′-diphenylmethane diisocyanate (2,4′-MDI), 2,2′-diphenylmethane diisocyanate (2,2′-MDI), hydrogenated MDI, monomeric diphenylmethane diisocyanate (monomeric MDI), and hexamethylene diisocyanate are more preferably contained.

The NCO % of the polyisocyanate is 10 to 70, preferably 20 to 60, and more preferably 30 to 55. When the NCO % of the polyisocyanate is in such a range, it is possible to obtain a polyurethane resin product which has good elongation, is hardly broken, and has high shape followability.

Here, the definition of NCO % is JIS K1603-1 “Plastic-polyurethane raw material aromatic isocyanate test method-Part 1: Method for determining isocyanate group content”, 3. Definition, 3.3 Isocyanate group content, “Amount of specific isocyanate present in sample expressed in mass fraction”. The NCO % is measured according to JIS K1603-1, Method B. Method B can be applied to purified or crude isocyanates of TDI, MDI and polymethylene polyphenyl isocyanate and modified isocyanates derived therefrom. The viscosity is in accordance with JIS K7301 “Test method for tolylene diisocyanate type prepolymer for thermosetting urethane elastomer, 6. Test method for general properties, 6.2 Viscosity”.

### Other Additives

The polyurethane resin can contain various additives in addition to the above-described components as necessary. Examples of the additive include a surfactant, a filler, a plasticizer, a pigment, a dye, an anti-aging agent, an antioxidant, an antistatic agent, a flame retardant, an adhesiveness imparting agent, an antibacterial agent, a light stabilizer, a stabilizer, a dispersant, a catalyst, a crosslinking agent, and a solvent.

### Method for Producing Adhesive Layer

As a method for producing the adhesive layer, a known method can be used. For example, a production example using a polyurethane resin is illustrated below.

Examples of the method for producing a polyurethane resin include a method in which a polyol component smaller than a theoretical amount is added dropwise to a reaction vessel containing a predetermined amount of a polyisocyanate component and then heated to react an isocyanate group of the polyisocyanate component with a hydroxyl group of the polyol to prepare a polyurethane prepolymer having an active isocyanate at a terminal, thereby producing a polyurethane resin composition. The reaction is usually carried out at a temperature of 50 to 120° C., preferably 60 to 100° C. The reaction time is usually 1 to 15 hours.

In the blending of the polyol and the polyisocyanate used in production of the polyurethane prepolymer, an equivalent ratio (hereinafter, it is referred to as an equivalent ratio of [isocyanate groups/hydroxyl groups]) between the isocyanate group of the polyisocyanate and the hydroxyl group of the polyol is preferably in the range of 0.7 to 1.5, and more preferably in the range of 0.8 to 1.2. As long as the equivalent ratio is in such a range, it is possible to obtain a polyurethane resin product which has good elongation, is hardly broken, and has high shape followability.

The polyurethane prepolymer can be usually produced in the absence of a solvent, but may be produced by reacting a polyol and a polyisocyanate in an organic solvent. When the reaction is performed in an organic solvent, an organic solvent that does not inhibit the reaction, such as ethyl acetate, n-butyl acetate, methyl ethyl ketone, or toluene, can be used, but it is necessary to remove the organic solvent by a method such as heating under reduced pressure during the reaction or after completion of the reaction.

When the isocyanate group-terminated polyurethane prepolymer is produced, a urethanization catalyst can be used as necessary. The urethanization catalyst can be appropriately added at any stage of the reaction. Examples of the urethanization catalyst include tertiary amines and metal compounds.

Examples of the tertiary amine include TEDA (Triethylenediamine, 1,4-diazabicyclo-[2.2.2] octane), N,N,N′,N′-tetramethylhexamethylenediamine, N,N,N′,N′-tetramethylpropylenediamine, N,N,N′,N′,N″-pentamethyldiethylenetriamine, trimethylaminoethylpiperazine, N,N-dimethylcyclohexylamine, N,N-dimethylbenzylamine, N-methylmorpholine, N-ethylmorpholine, triethylamine, tributylamine, bis (dimethylaminoalkyl) piperazine, N,N,N′,N′-tetramethylethylenediamine, N,N-diethylbenzylamine, bis (N,N-diethylaminoethyl) adipate, N,N,N′,N′-tetramethyl-1,3-butanediamine, N,N-dimethyl-β-phenylethylamine, 1,2-dimethylimidazole, and 2-methylimidazole.

Examples of the metal compound include carboxylates of tin such as dimethyltin dilaurate, dibutyltin dilaurate, dibutyltin maleate, dibutyltin diacetate, tin octylate, and tin naphthenate; titanate esters such as tetrabutyl titanate and tetrapropyl titanate; organic aluminum compounds such as aluminum trisacetylacetonate, aluminum trisethylacetoacetate, and diisopropoxyaluminum ethylacetoacetate; chelate compounds such as zirconium tetraacetylacetonate and titanium tetraacetylacetonate; octanoic acid metal salt such as lead octanoate and bismuth octanoate; and the like.

The number average molecular weight of the isocyanate group-terminated polyurethane prepolymer obtained by the above method is preferably in the range of 100 to 10,000, and more preferably in the range of 200 to 6,000. The number average molecular weight can be a numerical value measured by gel permeation chromatography and converted as a molecular weight of polystyrene as a standard sample.

The viscosity of the obtained polyurethane resin composition at 25° C. is preferably 50,000 mPa·s or less, more preferably 30,000 mPa·s or less, and still more preferably 15000 mPa·s or less. The lower limit is not particularly limited, but is, for example, 10 mPa·s. When the viscosity is more than 50,000 mPa·s, it is difficult to reduce the thickness during molding of the urethane resin product. Here, the viscosity can be measured according to JIS K 7117-1.

The obtained polyurethane resin composition can be molded into a sheet or the like, and then cured by light, heat, or the like to be used as an adhesive layer.

As a method for molding a polyurethane resin composition, the obtained polyurethane resin composition is defoamed under vacuum, then made to flow on a mold or a film subjected to a mold release treatment, and spread so as to have a predetermined film thickness using a film applicator or the like. Thereafter, the mixture is allowed to stand or heated in an oven at normal temperature to 150° C. for about 40 minutes to 2 days to cause a urethanization reaction. Thereafter, the molded adhesive layer can be obtained by removing the adhesive layer from the mold or the film.

### Physical Properties of Adhesive Layer

### Asker C Hardness

The Asker C hardness of the adhesive layer is 45 to 90, preferably 60 to 85. When the Asker C hardness of the adhesive layer is in such a range, the shape of the surface to be cleaned can be followed, and the performance of collecting contaminants is enhanced. In particular, when the optical connector is used for the connection end surface of the optical connector for an optical fiber in which the guide pin protrudes, it is possible to follow the shape of the guide pin, and the cleaning effect of the guide pin and the optical connector connection end surface can be remarkable.

The Asker C hardness of the adhesive layer is measured by the method described in JIS K7312:1996 “Physical Test Method for Thermosetting Polyurethane Elastomer Molded Product”. The measurement is performed using an Asker rubber hardness tester type C. As the adhesive layer used for the measurement, one that has been stored for 24 hours under an environment of 25° C. and 50% RH after completion of curing of the polyurethane resin is used.

### Tensile Properties Such as Tensile Strength

The tensile strength of the adhesive layer is 2.0 MPa or more and 30 MPa or less, and preferably 4.0 MPa or more and 22 MPa or less. When the tensile strength of the adhesive layer is in such a range, the shape of the surface to be cleaned can be followed, and the performance of collecting contaminants is enhanced. In particular, when the optical connector is used for the connection end surface of the optical connector for an optical fiber in which the guide pin protrudes, it is possible to follow the shape of the guide pin, and the cleaning effect of the guide pin and the optical connector connection end surface can be remarkable.

Breaking elongation of the adhesive layer may be 100 mm to 150 mm, and is preferably 105 mm to 140 mm. When the breaking elongation of the adhesive layer is in such a range, the shape of the surface to be cleaned can be followed, and the performance of collecting contaminants is enhanced. In particular, when the optical connector is used for the connection end surface of the optical connector for an optical fiber in which the guide pin protrudes, it is possible to follow the shape of the guide pin, and the cleaning effect of the guide pin and the optical connector connection end surface can be remarkable.

Further, a breaking elongation ratio of the adhesive layer may be 200% to 700%, and is preferably 400% to 650%. When the breaking elongation ratio of the adhesive layer is in such a range, the shape of the surface to be cleaned can be followed, and the performance of collecting contaminants is enhanced. In particular, when the optical connector is used for the connection end surface of the optical connector for an optical fiber in which the guide pin protrudes, it is possible to follow the shape of the guide pin, and the cleaning effect of the guide pin and the optical connector connection end surface can be remarkable.

The tensile strength of the adhesive layer is measured by a measurement method using a dumbbell test piece described in JIS K7312:1996 “Vulcanized Rubber and Thermoplastic Rubber-Determination of Tensile Properties”. The dumbbell test piece shape is a dumbbell-shaped No. 3 test piece, and is measured using a material testing machine. The measurement is performed at a crosshead speed of the material testing machine of 100 mm/min. At the same time, the breaking elongation and the breaking elongation ratio can be measured.

A tear strength of the adhesive layer can be 3N to 30N, and is preferably 5N to 16N. When the tear strength of the adhesive layer is in such a range, the shape of the surface to be cleaned can be followed, and the performance of collecting contaminants is enhanced. In particular, when the optical connector is used for the connection end surface of the optical connector for an optical fiber in which the guide pin protrudes, it is possible to follow the shape of the guide pin, and the cleaning effect of the guide pin and the optical connector connection end surface can be remarkable.

The tear strength of the adhesive layer is measured by a measurement method using an angle type test piece described in JIS K7312:1996 “Vulcanized rubber and thermoplastic rubber-Determination of tear strength”. The measurement is performed using a material testing machine. The measurement is performed at a crosshead speed of the material testing machine of 100 mm/min.

### Hysteresis Loss

A hysteresis loss of the adhesive layer is 3% or more and 60% or less, and preferably 5 to 50%. When the hysteresis loss of the adhesive layer is in such a range, the shape of the surface to be cleaned can be followed, and the performance of collecting contaminants is enhanced. In particular, when the optical connector is used for the connection end surface of the optical connector for an optical fiber in which the guide pin protrudes, it is possible to follow the shape of the guide pin, and the cleaning effect of the guide pin and the optical connector connection end surface can be remarkable.

The hysteresis loss of the adhesive layer is measured by the method described in JIS K7312:1996 “Physical Test Method for Thermosetting Polyurethane Elastomer Molded Product”. The measurement is performed by a tensile hysteresis test using a material testing machine. At this time, the shape of the test piece is a dumbbell-shaped No. 3 test piece, the crosshead speed of the material testing machine is set to 1000 mm/min, and the hysteresis loss after 30 cycles of tension and compression are repeated is measured.

The material of the base material is not particularly limited, and a known material can be used. For example, resins such as synthetic resins and natural resins, rubbers such as natural rubbers and synthetic rubbers, and natural fibers, synthetic fibers, fibers, and paper formed into a sheet shape can be used. Any of these materials can be used as long as they are not inhibited. For example, an extrusion-molded sheet of a resin, narrow cutting processing of a resin sheet, twisting of fibers, knitting of fibers (mesh material, woven fabric, and the like), laminated fabric, nonwoven fabric, paper, and the like can be used.

As the knitting of the fibers, for example, a mesh material having a network structure with a mesh opening of about 0.5 to 2.0 mm can be used.

In a case where the cleaning body CT is deformed so as to follow the shape of the guide pin GP and the hole when the cleaning body CT and the optical connector OC come into contact with each other, the cleaning body CT needs to have flexibility, and therefore the base material is preferably an olefin-based or polyvinyl chloride-based synthetic resin.

Meanwhile, in a case where the guide pin GP penetrates the cleaning body CT when the cleaning body CT and the optical connector OC come into contact with each other, it is preferable to use a base material having a structure that facilitates penetration or a material that facilitates penetration, and for example, a woven fabric, a laminated fabric, a nonwoven fabric, or the like of a fiber configured in a net shape can be suitably used.

When a material including fibers or voids such as a laminated fabric or a nonwoven fabric is used as the base material, a part of the adhesive layer can enter (impregnate) the voids of the base material. Such a state strengthens the adhesion between the base material and the adhesive layer. Therefore, when the ferrule end surface OE and the guide pin GP of the optical connector OC are removed from the cleaning body CT, the adhesive layer is detached from the base material and adheres to the ferrule end surface OE and the guide pin GP of the optical connector OC, which is advantageous in that adhesive residue hardly occurs.

As a base material made of a material that easily penetrates, paper, a nonwoven fabric, a woven fabric, or a resin film can be suitably used. The resin which is easily penetrated is not particularly limited, but a resin which easily breaks after exhibiting a certain elongation like a polyolefin resin such as a polyethylene resin, a resin subjected to easy cutting processing like a uniaxially or biaxially stretched polypropylene resin (PP) or a polyethylene terephthalate resin (PET), and the like can be suitably used.

A known material can be used for the release film, and is not particularly limited. A surface of a sheet-like material such as a resin film or paper on the adhesive layer side may be subjected to peeling processing. The peeling processing is not particularly limited, and examples thereof include a method of applying a peeling agent such as dimethylsiloxane.

### Configuration of Cleaning Tool 10

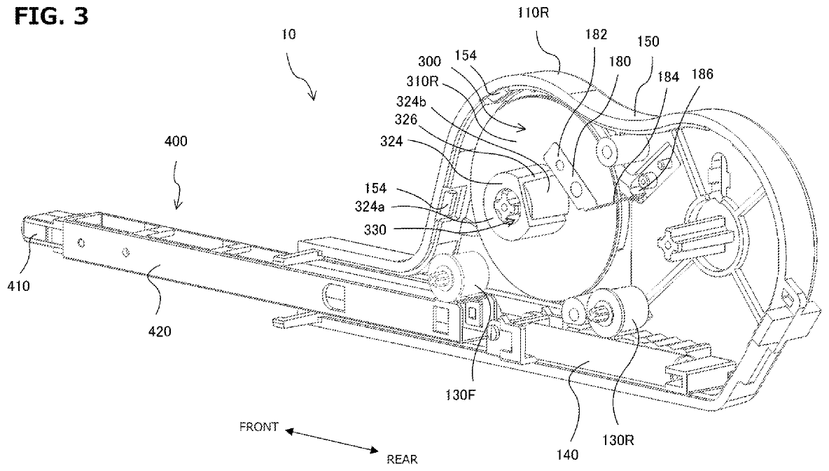

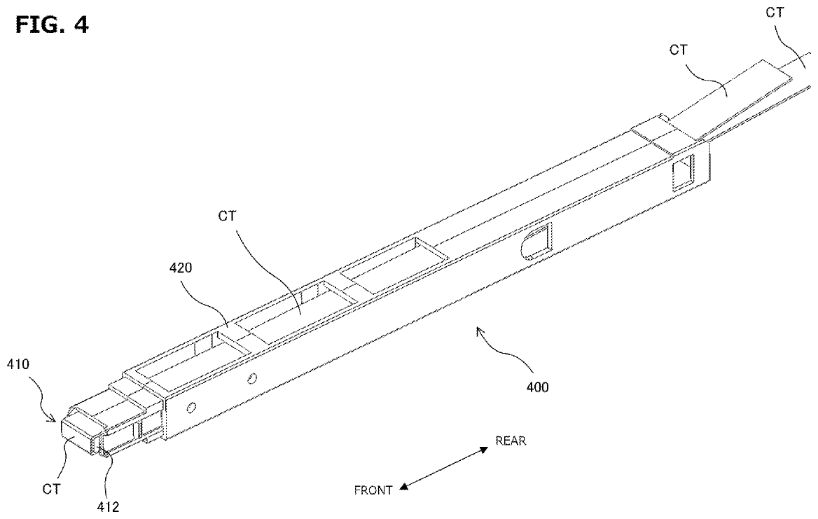

FIG. 1 is a perspective view illustrating an overall outline of the cleaning tool 10 and the optical connector OC according to the present embodiment. FIG. 2 is a perspective view illustrating a state in which a left housing 110L of the cleaning tool 10 according to the present embodiment is removed. FIG. 3 is a perspective view illustrating a state in which a winding reel 300 of the cleaning tool 10 according to the present embodiment is removed. FIG. 4 is a perspective view illustrating a path of the cleaning body CT in a head portion 400 of the cleaning tool 10 according to the present embodiment.

The cleaning tool 10 mainly includes the housing 100, the supply reel 200, the winding reel 300, the head portion 400, and a winding control body 500. The housing 100, the supply reel 200, the winding reel 300, the head portion 400, and the winding control body 500 are formed of ABS resin (acrylonitrile, butadiene, styrene copolymer synthetic resin), polyacetal (POM) resin, or the like. The material of the housing 100, the supply reel 200, the winding reel 300, the head portion 400, and the winding control body 500 is not limited thereto, and may be any material having a certain shape and durability.

### Housing 100

The housing 100 rotatably holds the supply reel 200 and the winding reel 300. The housing 100 has an elongated shape in the front-rear direction. The housing 100 stores the supply reel 200 and the winding reel 300 side by side in the front-rear direction. The winding reel 300 is located on the front side, and the supply reel 200 is located on the rear side.

The housing 100 has a recess 150 in a region between the supply reel 200 and the winding reel 300. The finger of the operator can be easily engaged with the recess 150, and the operation can be easily and accurately performed.

The housing 100 includes a right housing 110R and a left housing 110L. The housing constituting the right portion of the housing 100 is the right housing. The housing constituting the left portion of the housing 100 is the left housing. The right housing 110R has a locking claw 154, and the left housing 110L has a locking hole (not illustrated). The outer shape of the right housing 110R and the outer shape of the left housing 110L are formed approximately line-symmetrically. The right housing 110R and the left housing 110L face each other, and the locking claw of the right housing 110R is locked to the locking hole of the left housing 110L, whereby the housing 100 can be integrally formed.

### Right Housing 110R

The right housing 110R is a housing constituting a right portion of the housing 100.

### Cleaning Body Guide Roller 130F

A cleaning body guide roller 130F is rotatably provided between the winding reel 300 and the housing 100. The cleaning body guide roller 130F has a substantially cylindrical shape. The cleaning body guide roller 130F abuts on the cleaning body CT to curve the cleaning body CT, and changes the moving direction of the cleaning body CT. Specifically, the direction of the cleaning body CT returned from the cleaning head 410 can be changed to guide the cleaning body CT toward the winding reel 300. By adjusting the cleaning body CT toward the winding reel 300, the cleaning body CT can be stably wound around the winding reel 300.

### Cleaning Body Guide Roller 130R

A cleaning body guide roller 130R is rotatably provided between the supply reel 200 and the winding reel 300. The cleaning body guide roller 130R has a substantially cylindrical shape. The cleaning body guide roller 130R abuts on the cleaning body CT to curve the cleaning body CT, and changes the moving direction of the cleaning body CT. Specifically, the cleaning body CT fed from the supply reel 200 can be changed in a certain direction and guided toward the cleaning head 410. By adjusting the cleaning body CT to be directed in a certain direction, the cleaning body CT can be stably fed toward the cleaning head 410 without depending on the remaining amount of the cleaning body CT wound around the supply reel 200.

### Coil Spring 140

The coil spring 140 is a spring formed in a coil shape and is formed to be stretchable. In each drawing, the coil spring 140 is illustrated in a columnar shape for convenience. The coil spring 140 generates a biasing force according to a state of expansion and contraction. When the winding control body 500 moves to the rear side, the coil spring 140 contracts, and when the winding control body 500 moves to the front side, the coil spring 140 extends. The coil spring 140 applies a biasing force to the winding control body 500.

### Supply Reel Ratchet 180

The supply reel ratchet 180 has a leaf spring structure and has a fixed end portion 182 and a leaf spring portion 184. The fixed end portion 182 is fixed to the left housing 110L. The leaf spring portion 184 has an elongated shape, and can be bent and elastically deformed in a direction perpendicular to the longitudinal direction.

An engagement end 186 is provided at a tip of the leaf spring portion 184. The engagement end 186 has a bent shape. The engagement end 186 engages with a ratchet gear 222 of a pinion body 220 of the supply reel 200. The leaf spring portion 184 functions as a ratchet pawl. The ratchet mechanism by the leaf spring portion 184 will be described later.

### Supply Reel 200 and Winding Reel 300

A clean and unused cleaning body CT is wound around the supply reel 200 in advance in a drawable manner. The used cleaning body CT after cleaning the ferrule end surface OE of the optical connector OC is wound around the winding reel 300. The supply reel 200 and the winding reel 300 of the present embodiment have the same structure.

### Supply Reel 200

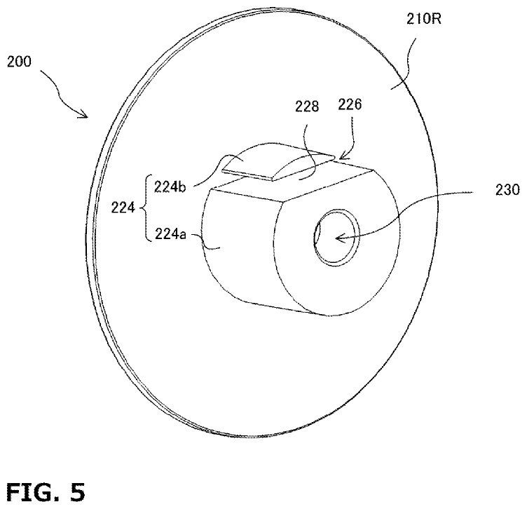

The supply reel 200 mainly includes a left supply reel frame 210L and a right supply reel frame 210R (see FIGS. 5 to 11). An unused cleaning body CT is wound between the left supply reel frame 210L and the right supply reel frame 210R so as to be able to be fed (supplied). It is sufficient that the cleaning body CT can be wound around the supply reel 200 so as to be able to be fed (supplied), and the cleaning body CT may be configured to include only one of the left supply reel frame 210L and the right supply reel frame 210R.

### Left Supply Reel Frame 210L

The left supply reel frame 210L has a substantially disk shape. The left supply reel frame 210L mainly includes a pinion body 220, an attachment portion 224, and a through hole 230.

### Pinion Body 220

The left supply reel frame 210L includes the pinion body 220. The pinion body 220 is formed outside the left supply reel frame 210L (side facing the left housing 110L). The pinion body 220 has a substantially cylindrical shape with a low height. The pinion body 220 is formed integrally and coaxially with the left supply reel frame 210L. The ratchet gear 222 is formed along an outer peripheral surface of the pinion body 220.

The ratchet gear 222 and the engagement end 186 of the supply reel ratchet 180 described above constitute a ratchet mechanism (return prevention mechanism). The ratchet mechanism allows the supply reel 200 to permit rotation in a first rotation direction (for example, clockwise) (rotation permitting direction), while prohibiting rotation in the second rotation direction (for example, counterclockwise) opposite to the first rotation direction (rotation prohibiting direction).

The operation transmittable state and the operation transmission difficult state from a control body 510 to the winding reel 300 can be defined by an operation transmission ratchet mechanism (not illustrated) of the winding reel 300. A rotation permitting state and a rotation prohibiting state of the winding reel 300 can be defined by a rotation direction defining ratchet mechanism (not illustrated) of the winding reel 300.

Further details of the structure of the supply reel 200 will be described later.

### Function of Supply Reel 200

An unused cleaning body CT is wound around a gap between the left supply reel frame 210L and the right supply reel frame 210R. When the supply reel 200 rotates, the unused clean cleaning body CT wound around the supply reel 200 can be gradually delivered and delivered toward the cleaning head 410. When the cleaning body is wound around and held by the supply reel 200, the adhesive resin layer (adhesive layer) is covered with the cleaning body CT that adjacently overlaps. When the winding is unwound, the cleaning bodies CT which are adjacently overlapped are separated, and the adhesive resin layer (adhesive layer) is exposed.

### Winding Reel 300

The winding reel 300 includes a right winding reel frame 310R. The used cleaning body CT after cleaning the ferrule end surface OE of the optical connector OC is wound around the winding reel 300.

In the present embodiment, there is no left winding reel frame, but a left winding reel frame may be provided. By providing the left winding reel frame, the cleaning body CT after being wound can be accurately held.

### Head Portion 400

As illustrated in FIG. 3, the head portion 400 is disposed so as to protrude forward from the housing 100. The head portion 400 includes the cleaning head 410 and a head holder 420.

### Cleaning Head 410

The cleaning head 410 includes a contact portion 412 for bringing the cleaning body CT into contact with the ferrule end surface OE of the optical connector OC. The contact portion 412 has a size and a shape corresponding to the ferrule end surface OE of the optical connector OC.

As illustrated in FIG. 4, the cleaning body CT fed from the supply reel is guided by the contact portion 412 and positioned at the contact portion 412. The cleaning head 410 can be detachably provided on the head holder 420. According to the ferrule end surface OE of the optical connector OC, the ferrule can be appropriately replaced with the corresponding cleaning head 410.

The adhesive layer RL of the cleaning body CT positioned in the contact portion 412 faces the ferrule end surface OE of the optical connector OC, and the adhesive layer RL is brought into contact with the ferrule end surface OE of the optical connector OC, whereby the dust present on the ferrule end surface OE of the optical connector OC is transferred to the adhesive layer RL. By this adhesion, dust on the ferrule end surface OE of the optical connector OC can be removed. Thereafter, the cleaning body CT is wound from the contact portion 412 toward the winding reel 300.

### Head Holder 420

The head holder 420 has a long and constant shape. Specifically, the head holder 420 has a long rectangular cylindrical shape and has a hollow structure. The head holder 420 movably accommodates the cleaning body CT from the supply reel 200 to the winding reel 300. Specifically, the head holder 420 movably accommodates the cleaning body CT which is fed from the supply reel 200, passes through the contact portion 412 of the cleaning head 410 described above, and is wound around the winding reel 300.

### Position of Cleaning Head 410

The cleaning head 410 is held at a certain position of the head holder 420 having a certain shape and locked at a certain position with respect to the housing 100. Therefore, the cleaning head 410 is always located at a constant position with respect to the housing 100. That is, the cleaning head 410 does not move with respect to the housing 100 before, during, and after the cleaning operation, and is always held at a constant position with respect to the housing 100 and the head holder 420. Since the cleaning head 410 is held at a constant position with respect to the housing 100 and the head holder 420, the cleaning body CT supplied to the contact portion 412 of the cleaning head 410 can be pressed against the ferrule end surface OE of the optical connector OC with a constant force, and the dust on the ferrule end surface OE can be stably removed without depending on the skill of the operator.

The front end of the cleaning head 410 protrudes from the head holder 420, and the contact portion 412 of the cleaning head 410 is disposed at a position protruding from the head holder 420. In this way, the cleaning body CT can be directed to the outside, and the cleaning body CT supplied to the contact portion 412 can be accurately brought into contact with the ferrule end surface OE of the optical connector OC.

### Winding Control Body 500

The winding control body 500 includes a control body 510.

### Control Body 510

The control body 510 has an elongated substantially rectangular cylindrical shape and penetrates in the longitudinal direction. That is, the control body 510 has a hollow structure, and the head portion 400 (the head holder 420 and the cleaning head 410) described above is accommodated inside the control body 510. The control body 510 can move along the longitudinal direction of the head portion 400 with respect to the head portion 400 accommodated inside. The control body 510 can move outside the head portion 400 along the longitudinal direction of the head portion 400, and the entire winding control body 500 can also move along the longitudinal direction of the head portion 400 with respect to the head portion 400 and the housing 100 by the movement of the control body 510.

When the operator applies a force to the cleaning tool 10, the control body 510 relatively moves to the rear side of the housing 100. By the movement of the control body 510, the contact portion 412 of the cleaning head 410 comes close to the ferrule end surface OE of the optical connector OC, and the cleaning body CT of the contact portion 412 comes into contact with the ferrule end surface OE. As a result, the clean adhesive layer RL of the cleaning body CT comes into contact with the ferrule end surface OE.

### Structure of Supply Reel 200

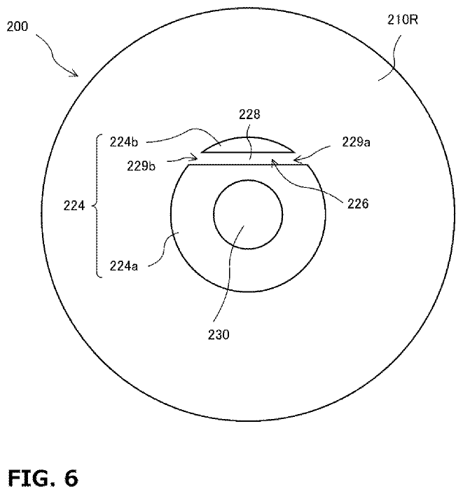

FIG. 5 is a perspective view illustrating a structure of the supply reel 200. FIG. 6 is a front view illustrating a structure of the supply reel 200.

As illustrated in FIGS. 5 and 6, the supply reel 200 includes the right supply reel frame 210R. The right supply reel frame 210R has a substantially disk shape. The right supply reel frame 210R has the attachment portion 224 and the through hole 230.

### Structure of Attachment Portion 224

The attachment portion 224 has a substantially columnar shape or a substantially cylindrical shape as a whole. The attachment portion 224 has a shape protruding from the right supply reel frame 210R. The attachment portion 224 functions as a rotation shaft serving as a rotation center of the supply reel 200. The attachment portion 224 also functions as a winding shaft that winds the cleaning body CT by the supply reel 200 rotating. The cleaning body CT is wound around an outer peripheral side surface (cylindrical side surface) of the attachment portion 224. A winding mode of the cleaning body CT will be described later.

The attachment portion 224 includes a first attachment portion 224a and a second attachment portion 224b. The first attachment portion 224a and the second attachment portion 224b are formed apart from each other. The first attachment portion 224a and the second attachment portion 224b have a substantially columnar shape or a substantially cylindrical shape. As described above, the attachment portion 224 has a substantially columnar shape or a substantially cylindrical shape as a whole. Both the first attachment portion 224a, the second attachment portion 224b, and a gap 226 described later have a substantially columnar or cylindrical shape as a whole.

The height of the first attachment portion 224a is slightly larger than the width of the cleaning body CT. The height of the second attachment portion 224b is lower than the height of the first attachment portion 224a. The heights of the first attachment portion 224a and the second attachment portion 224b may be the same. The attachment portion 224 has the gap 226 between the first attachment portion 224a and the second attachment portion 224b. The width of the gap 226 is substantially constant and is larger than the thickness of the cleaning body CT. As described later, the cleaning body CT can be disposed in the gap 226. By making the height of the second attachment portion 224b lower than the height of the first attachment portion 224a, it is possible to facilitate the operation of arranging the cleaning body CT in the gap 226.

The gap 226 is a region where the first attachment portion 224a and the second attachment portion 224b face each other and are sandwiched between the first attachment portion 224a and the second attachment portion 224b. The gap 226 has a substantially groove shape. The gap 226 has a front opening 228 facing the front in a front view. The front opening 228 has an elongated shape in a front view. The gap 226 has two first side openings 229a and a second side opening 229b. The two first side openings 229a and the second side openings 229b face the side surface in front view.

The first attachment portion 224a is formed to be larger than the second attachment portion 224b. Specifically, the outer peripheral side surface of the first attachment portion 224a is larger than the outer peripheral side surface of the second attachment portion 224b. The right supply reel frame 210R has the through hole 230. The gap 226 is formed at a position not interfering with the through hole 230, specifically, at a position separated from the through hole 230.

The cleaning body CT has a first surface RS provided with the adhesive layer and a second surface NS not provided with the adhesive layer. For example, in the case of a configuration in which an adhesive layer is formed on a base material, the adhesive layer is the first surface RS, and the base material is the second surface NS. The cleaning body CT has an elongated shape, and the first surface RS and the second surface NS face opposite sides to each other.

### Attaching Step 1 of Cleaning Body CT to Supply Reel 200 (Bobbin)

Attachment of the cleaning body CT to the supply reel 200 will be described with reference to FIGS. 7A to 7F. In FIGS. 7A to 7F, the first surface RS of the cleaning body CT is indicated by a black region, and the second surface NS of the cleaning body CT is indicated by a white region.

The operation of attaching the cleaning body CT to the supply reel 200 and winding the cleaning body CT is performed separately from the cleaning tool 10. That is, the operation of winding the cleaning body CT around the supply reel 200 is performed in a state where the supply reel 200 is not attached to the housing 100. For example, the supply reel 200 is rotatably attached on a winding machine (winder) (not illustrated). The winding machine includes a motor and the like, and can electrically rotate the supply reel 200. The cleaning body CT may be manually wound around the supply reel 200 without using a winding machine or the like. The cleaning body CT may be wound around the supply reel 200 using a manual winding machine instead of the motor.

### Start of Winding Cleaning Body CT Around First Attachment Portion 224a

As illustrated in FIG. 7A, the second surface NS of the cleaning body CT is disposed such that the second surface NS of the cleaning body CT faces (faces) the outer peripheral side surface of the first attachment portion 224a. An end portion SE of the cleaning body CT is positioned at the first attachment portion 224a near the first side opening 229a of the gap 226.

### Winding (First Winding) of Cleaning Body CT Around Outer Peripheral Side Surface of First Attachment Portion 224a

Next, as illustrated in FIG. 7B, the cleaning body CT is sequentially guided along the outer peripheral side surface of the first attachment portion 224a, and wound up to the second side opening 229b of the gap 226. In this example, the cleaning body CT is disposed clockwise along the outer peripheral side surface of the first attachment portion 224a.

### Disposing Cleaning Body CT in Gap 226

Next, as illustrated in FIG. 7C, the cleaning body CT is guided into the gap 226 from the second side opening 229b toward the first side opening 229a. The cleaning body CT is disposed such that the second surface NS of the cleaning body CT faces (faces) the outer peripheral side surface of the first attachment portion 224a. The second surface NS of the cleaning body CT is not provided with an adhesive layer, and the cleaning body CT does not adhere to the first attachment portion 224a.

### Winding (Second Winding) of Cleaning Body CT Around Outer Peripheral Side Surface of First Attachment Portion 224a

Next, as illustrated in FIG. 7D, the cleaning body CT is sequentially guided along the outer peripheral side surface of the first attachment portion 224a, and wound up to the second side opening 229b of the gap 226. That is, the cleaning body CT is wound on the cleaning body CT already wound around the outer peripheral side surface of the first attachment portion 224a. Also in this process, the cleaning body CT is arranged clockwise along the outer peripheral side surface of the first attachment portion 224a.

### Winding of Cleaning Body CT Around Second Attachment Portion 224b

Next, as illustrated in FIG. 7E, the cleaning body CT is reversed in the first side opening 229a and disposed so as to face the outer peripheral side surface of the second attachment portion 224b. Specifically, the cleaning body CT is bent and inverted at the end portion of the second attachment portion 224b on the first side opening 229a side.

Due to the reversal of the cleaning body CT, the cleaning body CT is guided such that the first surface RS of the cleaning body CT faces (faces) the outer peripheral side surface of the second attachment portion 224b. The first surface RS of the cleaning body CT is provided with an adhesive layer, and the cleaning body CT adheres to the second attachment portion 224b. The cleaning body CT is inverted, and thereafter, the cleaning body CT is arranged counterclockwise.

### Inversion

The reversal of the cleaning body CT means that the surface of the cleaning body CT facing the attachment portion 224 is changed from the second surface NS having no adhesive layer to the first surface RS having an adhesive layer. A case where the first surface RS is changed to the second surface NS is also included in the reversal of the cleaning body CT.

### Inversion Mode

In addition to the case where the cleaning body CT is inverted by bending, the cleaning body CT may be inverted by bending. In addition, the cleaning body CT may be gradually inverted over a predetermined region in addition to the case where the cleaning body CT is bent and inverted at one local place such as an end portion of the second attachment portion 224b on the first side opening 229a side. For example, the cleaning body CT may be gradually inverted (twisted) as the cleaning body CT is twisted and advances in the longitudinal direction.

Further, the case where the cleaning body CT is continuously and integrally inverted at the time of inversion has been described, but the cleaning body CT may be discontinuously inverted by once cutting the cleaning body CT.

### Winding of Cleaning Body CT Around First Attachment Portion 224a

Next, as illustrated in FIG. 7F, the cleaning body CT is wound around the first attachment portion 224a via the second side opening 229b. As described above, the cleaning body CT is inverted, and the first surface RS of the cleaning body CT adheres to the cleaning body CT already disposed on the first attachment portion 224a. Thereafter, the cleaning body CT is sequentially wound around the first attachment portion 224a. In this manner, the unused cleaning body CT is attached to the supply reel 200, and the cleaning tool 10 can be brought into a usable state.

As previously described, the supply reel 200 may be attached to the winding machine. The operations illustrated in FIGS. 7A to 7F are manually performed, and thereafter, the motor of the winding machine is driven to rotate the supply reel 200, and the cleaning body CT can be wound around the supply reel 200.

### State in which Cleaning Body CT is Attached to Supply Reel 200

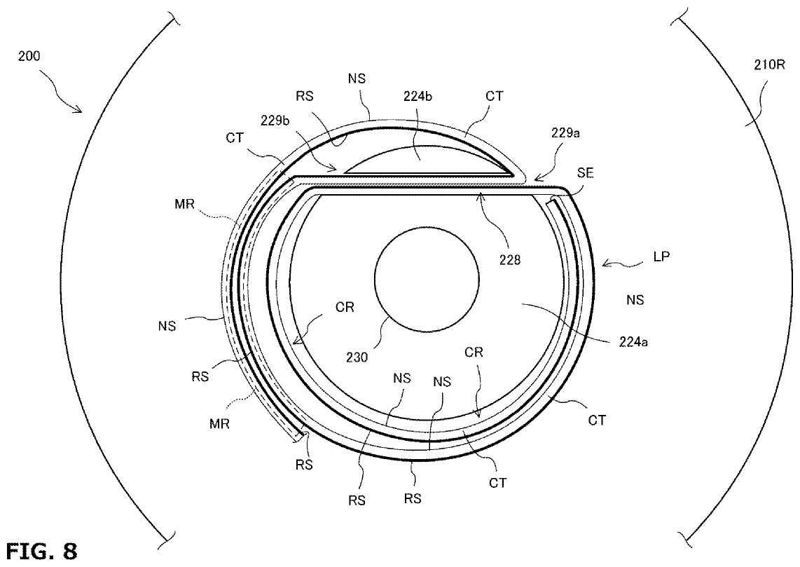

According to the above-described procedure, the cleaning body CT can be attached to the supply reel 200. FIG. 8 is a schematic view illustrating a state in which the cleaning body CT is attached to the supply reel 200.

### Clearance Region CR (Gap)

In this manner, the second surface NS of the cleaning body CT faces (faces) the entire circumference of the outer peripheral side surface of the first attachment portion 224a. Therefore, even when the cleaning body CT is in direct contact with the first attachment portion 224a, a portion of the cleaning body CT which is in direct contact with the first attachment portion 224a is not stuck (adhered) to (fixed to) the first attachment portion 224a. Therefore, the clearance region CR (gap) can be actively formed between the first attachment portion 224a and the cleaning body CT.

### Annular Portion LP

As illustrated in FIG. 8, the annular portion LP can be formed by a portion where the second surface NS of the cleaning body CT faces (faces) the outer peripheral side surface of the first attachment portion 224a. The cleaning body CT has the first surface RS having the adhesive layer and the second surface NS having no adhesive layer. Facing the outer peripheral side surface of the first attachment portion 224a means being located closer to the outer peripheral side surface of the first attachment portion 224a. That is, the fact that the second surface NS of the cleaning body CT faces the outer peripheral side surface of the first attachment portion 224a means that the second surface NS of the first surface RS and the second surface NS is located closer to the outer peripheral side surface of the first attachment portion 224a than the first surface RS.

The annular portion LP is configured by a portion (innermost peripheral portion) where the second surface NS of the cleaning body CT circles on the innermost side facing the outer peripheral side surface of the first attachment portion 224a. In the example illustrated in FIGS. 7A to 8, the portion where the second surface NS of the cleaning body CT faces the outer peripheral side surface of the first attachment portion 224a goes around the outer peripheral side surface of the first attachment portion 224a twice. The annular portion LP is formed by two rounds of the cleaning body CT. Only the annular portion LP of the cleaning body CT wound around the attachment portion 224 can be in contact with the outer peripheral side surface of the first attachment portion 224a. The clearance region CR is formed between the annular portion LP and the first attachment portion 224a. In other words, the annular portion LP is attached to the first attachment portion 224a with slight play (be loosely attached, loosely fitted, loosely attached). Due to the formation of the clearance region CR, the annular portion LP of the cleaning body CT comes into contact with the first attachment portion 224a so as to be slightly movable (slidable, movable, displaceable, deformable) in the radial direction, the circumferential direction, or the like of the attachment portion 224 according to the size of the clearance region CR.

When the cleaning tool 10 is used to clean the ferrule end surface OE of the optical connector OC, the cleaning body CT is drawn out from the supply reel 200 while the supply reel 200 rotates. Each time cleaning is performed, the supply reel 200 rotates, and the cleaning body CT is drawn out from the supply reel 200. When the entire cleaning body CT is pulled out from the supply reel 200 (used up), only the annular portion LP remains on the supply reel 200, and the supply reel 200 cannot rotate. In this way, by making the supply reel 200 not rotatable, it is possible to clearly notify the user that all the cleaning bodies CT have been used up and the end point has been reached.

### Aspect of Annular Portion LP

Although the example in which the second surface NS of the cleaning body CT faces the outer peripheral side surface of the first attachment portion 224a and the cleaning body CT is caused to circle around the outer peripheral side surface of the first attachment portion 224a to form the annular portion LP has been described, the annular portion LP is not limited thereto. For example, the annular portion LP may be formed to face the second surface NS of the cleaning body CT only in a region (region shorter than one round) shorter than the entire circumference of the outer peripheral side surface of the first attachment portion 224a. Further, the annular portion LP may be formed by making the second surface NS of the cleaning body CT face the outer peripheral side surface of the first attachment portion 224a and causing the cleaning body CT to circle around the outer peripheral side surface of the first attachment portion 224a multiple times.

### Operation of Cleaning Body CT in Process of Attaching (Winding) to Supply Reel 200

In order to cause the cleaning tool 10 to function as a cleaner, it is necessary to wind the cleaning body CT around the supply reel 200 in advance. Therefore, a step of winding the cleaning body CT around the supply reel 200 is required. The winding step of the cleaning body CT is a steps of winding the cleaning body CT around the attachment portion 224 by rotating the supply reel 200. As described above, the cleaning body CT can be wound around the supply reel 200 using the winding machine or the like.

The step of winding the cleaning body CT around the attachment portion 224 is a step of gradually winding the cleaning body CT around the annular portion LP formed at the innermost peripheral portion. Due to the clearance region CR formed between the annular portion LP and the first attachment portion 224a, in the process of winding the cleaning body CT, the annular portion LP slides, moves, displaces, or deforms with respect to the first attachment portion 224a in accordance with the rotation of the supply reel 200.

In the process of winding the cleaning body CT, the cleaning body CT is wound while finely adjusting the posture and position of the cleaning body CT by sliding, movement, displacement, and deformation of the annular portion LP, so that stress applied to the cleaning body CT can be dispersed. That is, even when stress is intensively applied to a specific position in the width direction of the cleaning body CT in the winding process, the posture and position of the annular portion LP are finely adjusted by sliding, movement, displacement, and deformation of the annular portion LP. By fine adjustment of the annular portion LP, uniform stress (stress close to uniform stress) is applied to the cleaning body CT over the entire width direction of the cleaning body CT, and the cleaning body CT can be wound after distortion generated by the stress is released. In other words, the cleaning body CT can be wound around the supply reel 200 after stress applied to the cleaning body CT at the time of winding is dispersed to release distortion such as shear stress and shear strain generated in the cleaning body CT. That is, the distortion generated in the cleaning body CT can be released before the cleaning body CT is wound around the supply reel 200. Therefore, the cleaning body CT can be wound around the supply reel 200 so that the distortion is not accumulated in the cleaning body CT. In this way, after the entire cleaning body CT is wound around the supply reel 200, for example, a phenomenon in which the cleaning body CT is displaced (laterally displaced) in the width direction of the supply reel 200 with time and is displaced in a spiral shape (so-called bamboo shoot shape) during use of the supply reel 200 can be prevented.

### Lamination Region MR

As described above, the cleaning body CT is bent and inverted at the end portion of the second attachment portion 224b on the first side opening 229a side, and is wound while being overlapped on the cleaning body CT already wound around the outer peripheral side surface of the first attachment portion 224a. Therefore, as illustrated in FIG. 8, a lamination region MR in which the first surfaces RS having the adhesive layer overlap is formed. In FIG. 8, the two first surfaces RS are illustrated separately for clarity. The lamination region MR functions as an adhesive layer in which the thickness of the adhesive layer is doubled. As the thickness is doubled, a restoring force (biasing force) generated by the lamination region MR is increased, and the stress applied to the lamination region MR can be alleviated quickly. The distortion generated in the lamination region MR can be easily eliminated.

Even in the process of winding the cleaning body CT around the attachment portion 224 of the supply reel 200 one after another, when the stress applied to the cleaning body CT propagates to the lamination region MR, distortion occurs in the lamination region MR. The distortion generated in the lamination region MR is quickly eliminated by the stress relaxation of the adhesive layer in the lamination region MR. By forming the lamination region MR, it is possible to more accurately prevent a phenomenon in which the cleaning body CT is displaced (laterally displaced) in the width direction of the supply reel 200 with time and is displaced in a spiral shape (so-called bamboo shoot shape), for example, during use of the supply reel 200 after the entire cleaning body CT is wound around the supply reel 200.

### Attaching Step 2 of Cleaning Body CT to Supply Reel 200 (Bobbin)

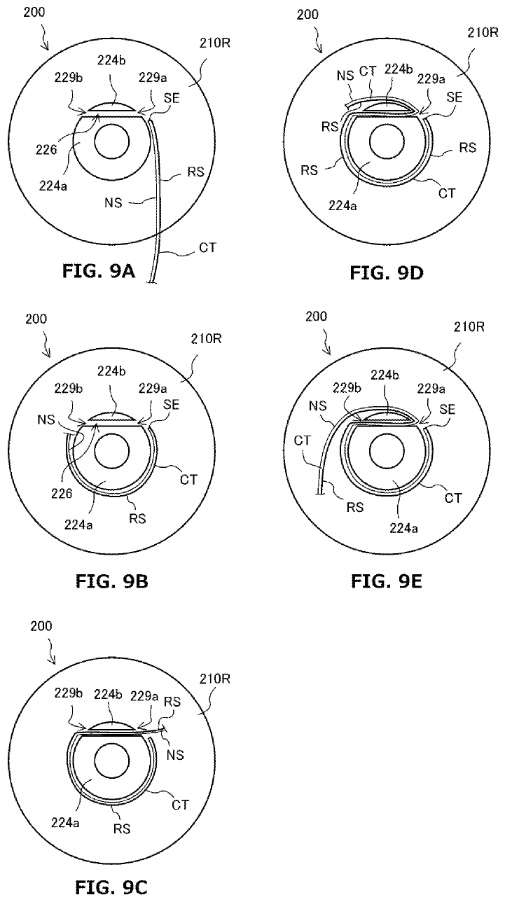

The attachment of the cleaning body CT to the supply reel 200 will be described with reference to FIGS. 9A to 9E. Moreover, in FIGS. 9A to 9E, similarly to FIGS. 7A to 7F, the first surface RS of the cleaning body CT is indicated by a black region, and the second surface NS of the cleaning body CT is indicated by a white region.

In FIGS. 7A to 7F, first, the cleaning body CT is wound around the outer peripheral side surface of the first attachment portion 224a clockwise up to the second turn so that the second surface NS of the cleaning body CT faces the outer peripheral side surface of the first attachment portion 224a. The winding portion for two turns constitutes the annular portion LP. In FIGS. 9A to 9E, the cleaning body CT is wound up to the first turn around the outer peripheral side surface of the first attachment portion 224a. The winding portion for one turn constitutes the annular portion LP.

The processes from FIGS. 9A to 9C are the same as those in FIGS. 7A to 7C. Thereafter, the processes in FIGS. 9D and 9E are the same as those in FIGS. 7E and 7F. In this manner, the cleaning body CT is wound only one turn.

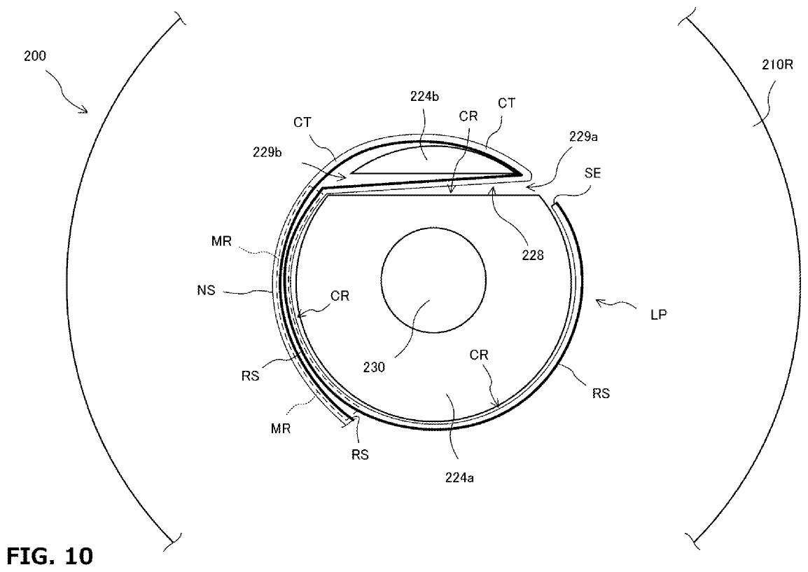

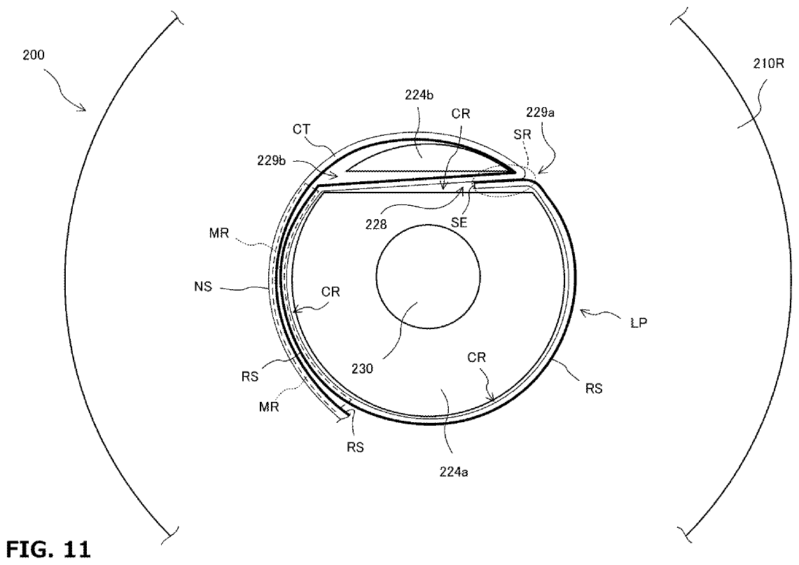

In FIGS. 9A to 10, in order to clarify the attachment step, a winding start end portion SE of the cleaning body CT is illustrated at a position spaced apart from the first side opening 229a of the gap 226. Preferably, as illustrated in FIG. 11, the overlapping region SR is provided to attach the cleaning body CT. FIG. 11 is the same as FIG. 10 except that an overlapping region SR is provided. Also in FIG. 11, the first surface RS of the cleaning body CT is indicated by a black region, and the second surface NS of the cleaning body CT is indicated by a white region.

As illustrated in FIGS. 10 and 11, the second surface NS of the cleaning body CT faces only a part or all of the outer peripheral side surface of the first attachment portion 224a, so that the annular portion LP can be formed by the facing portions.

As illustrated in FIGS. 10 and 11, the lamination region MR in which the adhesive layers RL overlap each other is formed. The restoring force (biasing force) generated by the lamination region MR is increased, the stress applied to the lamination region MR is quickly alleviated, and the distortion generated in the lamination region MR can be eliminated.

### Modification 1

In the example described above, the supply reel 200 has been described, but the winding reel 300 may be used. As illustrated in FIG. 3, the winding reel 300 has the same configuration as the supply reel 200. Similarly to the supply reel 200, the winding reel 300 has an attachment portion 324. The attachment portion 324 has a first attachment portion 324a and a second attachment portion 324b. A gap 326 is provided between the first attachment portion 324a and the second attachment portion 324b.

Even when the cleaning body CT after cleaning is wound around the winding reel 300, the stress applied to the cleaning body CT is dispersed to release the distortion generated in the cleaning body CT, and the cleaning body CT can be wound around the winding reel 300. It is possible to prevent a phenomenon in which the cleaning body CT is displaced in a spiral shape (so-called bamboo shoot shape) by being biased (laterally displaced) in the width direction of the winding reel 300 over time.

### Modification 2

In the winding of the cleaning body CT around the attachment portion 224 described above, first, the cleaning body CT is wound such that the second surface NS of the cleaning body CT faces the outer peripheral side surface of the first attachment portion 224a, and then, the cleaning body CT is reversed, and the cleaning body CT is wound such that the first surface RS faces the second attachment portion 224b and the first attachment portion 224a. The present invention is not limited to this, after the cleaning body CT is wound so that the first surface RS faces the second attachment portion 224b and the first attachment portion 224a, the cleaning body CT may be reversed again so that the second surface NS of the cleaning body CT faces the second attachment portion 224b and the first attachment portion 224a, and further, the cleaning body CT may be reversed so that the first surface RS faces the second attachment portion 224b and the first attachment portion 224a. In this way, the clearance regions CR can be provided at a plurality of places, and the posture and position of the cleaning body CT can be more easily finely adjusted and wound, so that the distortion generated in the cleaning body CT can be easily released, and the cleaning body CT can be wound around the supply reel 200. After the entire cleaning body CT is wound around the supply reel 200, it is possible to prevent a phenomenon in which the cleaning body CT is displaced (laterally displaced) in the width direction of the supply reel 200 with time and is displaced in a spiral shape (so-called bamboo shoot shape), for example, during use of the supply reel 200.

### Modification 3

In the example described above, the attachment portion 224 has two fixing portions of the first attachment portion 224a and the second attachment portion 224b, but may have three or more fixing portions. It is sufficient that the annular portion LP can be formed and the cleaning body CT can be reversed.

### Modification 4

The adhesive layer may have a low adhesive element and a large rubber-like element. When an adhesive layer having such properties is used, lateral displacement is likely to occur due to winding tightening. Therefore, it is effective to attach the cleaning body CT to the supply reel 200 by the above-described attachment method.

### Modification 5

In the above-described example, the annular portion LP is formed so as to have the clearance region CR. However, the annular portion LP may be formed by disposing a cushion member instead of the clearance region CR. The presence of the cushion member enables the annular portion LP to reliably slide, move, displace, and deform, and fine adjustment of the posture and position of the annular portion LP enables stress applied to the cleaning body CT to be dispersed. As the cushion member, any member having a stress relaxation property such as a C-shaped spring can be used.

### Range of Present Embodiment

As described above, the present invention has also been described as the present embodiment, but the description and drawings constituting a part of this disclosure should not be understood as limiting the present invention. Thus, the present invention includes various embodiments and the like that are not described herein.

In the present embodiment, the cleaning body CT for cleaning the ferrule end surface OE of the optical connector OC has been described as an example of the object to be attached of the structure for attaching an object to be attached or the method for attaching an object to be attached. The structure for attaching an object to be attached or the method for attaching an object to be attached are not limited to the cleaning body CT, and any medium may be used as long as the medium has a first surface having an adhesive layer and a second surface (base material or the like) that is a surface on a side opposite to the first surface and has no adhesive layer. In particular, the present invention can be applied to a medium having flexibility. Furthermore, the present invention can be applied to a long medium. For example, the present invention can be applied to a so-called adhesive tape. The base material can be applied to a medium including paper, cloth, resin, metal foil, or the like.
10 cleaning tool
100 housing
200 supply reel
224 attachment portion
224b second attachment portion (engagement portion)
300 winding reel
CT cleaning body (object to be attached)
RL adhesive layer
RS surface having adhesive layer (first surface)
NS surface without adhesive layer (second surface)

1. A structure for attaching an object to be attached, comprising:
an object to be attached including a first surface having an adhesive layer and a second surface which is a surface on a side opposite to the first surface and has no adhesive layer; and
an attachment portion to which the object to be attached is attached to face the second surface of the object to be attached, at least a part of the object to be attached being deformable in a state where the object to be attached is attached.

2. The structure for attaching an object to be attached according to claim 1, wherein at least a part of the object to be attached is deformable in a direction away from or approaching the attachment portion.

3. The structure for attaching an object to be attached according to claim 2, wherein after the object to be attached is attached to face the second surface of the object to be attached, the object to be attached is attached so that the first surface of the object to be attached faces the attachment portion.

4. The structure for attaching an object to be attached according to claim 3, wherein after the object to be attached is wound in a first winding direction to face the second surface of the object to be attached, the object to be attached is wound in a second winding direction different from the first winding direction so that the first surface of the object to be attached faces the attachment portion.

5. The structure for attaching an object to be attached according to claim 4, wherein the attachment portion includes an engagement portion engageable with the object to be attached and configured to change a winding direction of the object to be attached from the first winding direction to the second winding direction by engagement.

6. A method for attaching an object to be attached comprising: attaching an object to be attached to an attachment portion so that the attachment portion faces a second surface of the object to be attached including a first surface having an adhesive layer and the second surface which is a surface on a side opposite to the first surface and has no adhesive layer,
wherein at least a part of the object to be attached is deformable in a state where the object to be attached is attached.

7. The method for attaching an object to be attached according to claim 6, wherein after the object to be attached is attached to the attachment portion to face the second surface of the object to be attached, the object to be attached is attached to the attachment portion to face the first surface of the object to be attached.

8. The method for attaching an object to be attached according to claim 7, wherein after the object to be attached is wound in a first winding direction to face the second surface of the object to be attached, the object to be attached is guided in a second winding direction different from the first winding direction and the first surface of the object to be attached is wound to face the attachment portion.
